(19) United States
(12) Patent Application Publication
(10) Pub. No.: US 2025/0190176 A1
(43) Pub. Date: Jun. 12, 2025

(54) TECHNIQUE FOR GENERATING AN OUTPUT VALUE REPRESENTING A SHIFTED INPUT VALUE

(71) Applicant: Arm Limited, Cambridge (GB)

(72) Inventor: David Raymond LUTZ, Austin, TX (US)

(21) Appl. No.: 18/536,765

(22) Filed: Dec. 12, 2023

(51) Int. Cl. G06F 7/76; G06F 7/483

(52) U.S. Cl. CPC G06F 7/764; G06F 7/483

(57) ABSTRACT

A technique is provided for performing a computation equivalent to applying a shift to an input value to generate an output value. Mask generation circuitry is used to generate an N-bit mask in dependence on a provided shift amount indication. N is a number of possible bit positions that a given bit of the input value may be located within the output value after the shift is performed. The mask generation circuitry performs N independent logical operations on bits forming the shift amount indication, each logical operation producing a mask bit value for a corresponding bit position of the N-bit mask, and the N logical operations being arranged such that, for any given shift amount indication, only one bit position in the generated N-bit mask will have its mask bit value indicating a set state. Output value generation circuitry is used to apply the N-bit mask to the given bit of the input value in order to determine a corresponding location of the given bit within the output value, and to determine a location within the output value of each other bit of the input value in dependence on the corresponding location of the given bit.

### BACKGROUND

The present technique relates to the field of data processing, and more particularly to techniques for generating an output value representing a shifted input value.

There are many situations when performing data processing operations where it is required to perform a shift operation on an input value. However, when employing typical shift logic circuitry, the time taken to perform the required shift operation on an input value can be significant, and this can adversely affect performance.

It would be desirable to enable the time taken to perform a shift operation to be reduced, so as to reduce the delay associated with performing shift operations on data.

### SUMMARY

In accordance with a first example arrangement, there is provided an apparatus for performing a computation equivalent to applying a shift to an input value to generate an output value, comprising: mask generation circuitry to generate an N-bit mask in dependence on a provided shift amount indication, where N is a number of possible bit positions that a given bit of the input value may be located within the output value after the shift is performed, wherein the mask generation circuitry is arranged to perform N independent logical operations on bits forming the shift amount indication, each logical operation producing a mask bit value for a corresponding bit position of the N-bit mask, and the N logical operations being arranged such that, for any given shift amount indication, only one bit position in the generated N-bit mask will have its mask bit value indicating a set state; and output value generation circuitry to apply the N-bit mask to the given bit of the input value in order to determine a corresponding location of the given bit within the output value, and to determine a location within the output value of each other bit of the input value in dependence on the corresponding location of the given bit.

In accordance with a second example arrangement, there is provided a system comprising: the apparatus in accordance with the first example arrangement, implemented in at least one packaged chip; at least one system component; and a board, wherein the at least one packaged chip and the at least one system component are assembled on the board.

In accordance with a further example arrangement, there is provided a chip-containing product comprising the system in accordance with the second example arrangement, assembled on a further board with at least one other product component.

In accordance with a yet further example arrangement, there is provided a computer-readable medium to store computer-readable code for fabrication of an apparatus in accordance with the first example arrangement discussed above. The computer-readable medium may be a transitory computer-readable medium or a non-transitory computer-readable medium.

In accordance with a still further example arrangement, there is provided a method of performing a computation equivalent to applying a shift to an input value to generate an output value, comprising: employing mask generation circuitry to generate an N-bit mask in dependence on a provided shift amount indication, where N is a number of possible bit positions that a given bit of the input value may be located within the output value after the shift is performed, the mask generation circuitry performing N independent logical operations on bits forming the shift amount indication, each logical operation producing a mask bit value for a corresponding bit position of the N-bit mask, and the N logical operations being arranged such that, for any given shift amount indication, only one bit position in the generated N-bit mask will have its mask bit value indicating a set state; and applying the N-bit mask to the given bit of the input value in order to determine a corresponding location of the given bit within the output value, and determining a location within the output value of each other bit of the input value in dependence on the corresponding location of the given bit.

### BRIEF DESCRIPTION OF THE DRAWINGS

Further aspects, features and advantages of the present technique will be apparent from the following description of examples, which is to be read in conjunction with the accompanying drawings, in which:

FIG. 1 is a block diagram schematically illustrating an apparatus in accordance with one example implementation;

FIG. 2 is a block diagram illustrating in more detail the mask generation circuitry of FIG. 1, in accordance with one example implementation;

FIG. 3 illustrates circuitry that may be used to implement a logical operation instance of FIG. 2, in accordance with a specific example implementation;

FIG. 4 is a block diagram illustrating in more detail the output value generation circuitry of FIG. 1, in accordance with one example implementation;

FIG. 5 illustrates circuitry that may be used to implement an instance of the intermediate result generator of FIG. 4, in accordance with one example implementation;

FIG. 6 illustrates circuitry that may be used to implement the combining circuitry of FIG. 4, in accordance with a specific example implementation;

FIG. 7 is a flow diagram illustrating the steps performed in one example implementation in order to generate an output value representing a shifted input value;

FIG. 8 schematically illustrates how a mask may be applied to an input value in order to perform a computation equivalent to a shift when generating an output value, in accordance with one example implementation;

FIG. 9 schematically illustrates how a mask may be applied to a floating point input value in order to perform a computation equivalent to a shift when generating a fixed point output value, in accordance with one example implementation;

FIG. 10 schematically illustrates how a mask may be applied to an input value in order to perform a computation equivalent to a shift that implements a rotation of the input value, in accordance with one example implementation; and

FIG. 11 illustrates a system and a chip-containing product.

### DESCRIPTION OF EXAMPLES

In accordance with the techniques described herein, an apparatus is provided that can perform a computation equivalent to applying a shift to an input value in order to generate an output value. However, rather than using conventional shift logic circuitry to perform the shift, the technique described herein instead makes use of a mask that can be applied to the input value in order to generate the required output value.

In particular, the apparatus has mask generation circuitry to generate an N-bit mask in dependence on a provided shift amount indication, where N is a number of possible bit positions that a given bit of the input value may be located within the output value after the shift is performed. The mask generation circuitry is arranged to perform N independent logical operations on bits forming the shift amount indication, each logical operation producing a mask bit value for a corresponding bit position of the N-bit mask. Since the N logical operations are independent of each other, there is a great deal of flexibility as to how the logical operations are performed, and in one example implementation the logical operations are performed in parallel so that all of the N mask bit values required for the mask can be generated in parallel.

The N logical operations are arranged such that, for any given shift amount indication, only one bit position in the generated N-bit mask will have its mask bit value indicating a set state. The value used to indicate the set state may be varied dependent on implementation. In one example implementation, a value of 1 is used to indicate the set state, and a value of 0 is used to indicate the unset (or clear) state, and hence in such an implementation only one bit position in the N-bit mask will have its mask bit value set to 1. However, it will be appreciated that in an alternative implementation a value of 0 could be used to indicate the set state and a value of 1 could be used indicate the clear state, in which case only one bit position in the N-bit mask would have its mask bit value set to 0.

The apparatus further has output value generation circuitry that is used to apply the N-bit mask to the given bit of the input value in order to determine a corresponding location of the given bit within the output value, and to determine a location within the output value of each other bit of the input value in dependence on the corresponding location of the given bit.

By such an approach, it has been found that the delay associated with applying a shift to an input value can be significantly reduced, thereby enabling significant performance improvements to be realised in an apparatus where the application of shifts to data values is often required.

The shift indication amount can take a variety of forms. However, in one example implementation, the shift indication amount is an X-bit value, and each logical operation uses X inputs chosen from non-inverted and inverted versions of each bit of the shift indication amount, such that each logical operation has a different X inputs to any other logical operation of the N logical operations. The logical operations are chosen such that, for all combinations of possible values of the X bits forming the shift indication amount, only one of the logical operations will produce a mask bit value that is in the set state.

The logical operations performed can take a variety of forms, dependent on implementation. However, in one example implementation, each logical operation is arranged to perform a logical AND of the X inputs provided for that that logical operation. In such an example implementation, only one of the logical operations will receive as inputs all 1s, and hence only one of the logical operations will produce an output of 1, which in one example implementation can be used to indicate the set state.

The number of bits forming the output value, and the bit length size of the output value relative to the input value, may vary dependent on implementation. In one example implementation, the output value comprises at least N bits, and hence is at least as large as the mask. In one such example implementation, the output value generation circuitry is then arranged to align the N-bit mask with N bit positions of the output value such the corresponding location of the given bit within the output value is identified by the one bit position in the generated N-bit mask that has the mask bit value indicating the set state.

There are various ways in which the location within the output value of each other bit of the input value can be determined, in dependence on the corresponding location of the earlier-mentioned given bit. However, in one example implementation, the output value generation circuitry is arranged to apply a shifted version of the N-bit mask to each other bit of the input value other than the given bit in order to determine a corresponding location of each other bit within the output value. For any selected other bit of the input value the shifted version of the N-bit mask is arranged to adjust for a number of bit positions between the given bit and the selected other bit. By such an approach, it has been found that the same N-bit mask can be reused, albeit in a logically shifted form, to work out the position within the output value of each bit of the input value. This can lead to a particularly efficient implementation.

Indeed, in one example implementation, each shifted version of the N-bit mask is achieved by rewiring of the N-bit mask. Hence no logic is required in order to generate each shifted version of the N-bit mask, and instead simple wiring patterns can be used to move the N-bit mask to align it appropriately with respect to the bit positions of the output value so as to cause each bit of the input value to be located correctly within the output value in order to produce a result equivalent to applying a shift to the input value. This can lead to a significant reduction in the time taken to produce the output value, when compared with techniques using conventional shift logic circuits.

In one example implementation, a given shifted version of the N-bit mask used for a given other bit of the input value comprises the N-bit mask aligned with N bit positions of the output value such the corresponding location of the given other bit within the output value is identified by the one bit position in the given shifted version of the N-bit mask that has the mask bit value indicating the set state. Hence, a simple application of that shifted version of the N-bit mask can be used to propagate the value of the given other bit from the input value to the corresponding location in the output value. For example, in situations where the single bit of the N-bit mask that is in the set state has a value of 1, the given other bit of the input value can be replicated N times to produce an N-bit value which is then logically AND-ed with the given shifted version of the N-bit mask in order to propagate the value of that given other bit into the corresponding location within the output value.

In one example implementation, the input value comprises L bits, and L−1 shifted versions of the N-bit mask are formed, each shifted version being associated with one of the L−1 other bits of the input value.

In such an example implementation, the output value generation circuitry may be arranged to generate L intermediate results, each intermediate result being generated by applying a version of the N-bit mask to its associated bit of the input value, and the output value generation circuitry may comprise combining circuitry to logically combine the L intermediate results to generate the output value.

As mentioned earlier, the number of bits forming the output value may vary dependent on implementation. However, in one example implementation the output value has P bits, where P is greater than N. In such an implementation, the output value generation circuitry may be arranged to generate each intermediate result such that that intermediate result includes P-N padding bit values provided in at least one of most significant bit positions and least significant bit positions of the intermediate result. The number of padding bit values added in most significant bit positions and the number of padding bit values added in least significant bit positions will depend on the bit of the input value associated with each intermediate result in question.

The given bit of the input value that the N-bit mask is applied to may vary dependent on implementation, but in one example implementation the given bit is the most significant bit of the input value. In such an implementation, the intermediate result generated by applying the N-bit mask to the given bit has padding bits provided in the P-N least significant bit positions, and the intermediate result generated for each successive less significant bit of the input value has one more padding bit in the most significant bit positions than the intermediate result generated for an adjacent more significant bit of the input value.

In one particular example implementation P=N+L−1, where as mentioned earlier L represents the number of bits in the input value. In this particular example implementation, the most significant bit of the input value is positioned within one of the N bit positions of the output value identified by the N-bit mask, and each less significant bit of the input value is positioned in a corresponding less significant bit position of the output value. By arranging for the output value to have N+L−1 output bits, and aligning the N-bit mask with the most significant N bit positions of the output value, this means that even in situations where the most significant bit of the input value is placed within the output value in the least significant bit position identified by the N-bit mask, the remaining L−1 bits of the input value can be positioned within the output value at corresponding less significant bit positions than the bit position of the output value used to accommodate the most significant bit of the input value.

The number of bits in the output value and the number of bits in the input value may vary dependent on implementation. For example, in some implementations there may be the same number of bits in the output value as in the input value. However, in one example implementation the output value has more bits than the input value, the input value comprises L bits, and the output value generation circuitry is arranged to apply the N-bit mask so as to replicate the input value in a sequence of L bit positions within the output value. The N-bit mask is hence effectively used to decide where within the output value that sequence should be placed.

In one such example implementation, the output value generation circuitry is arranged to generate the output value such that each bit position other than the L bit positions has its value set to a predetermined value. The predetermined value can take a variety of forms. For example, in one implementation the predetermined value may be a 0, such that the input value is replicated in a sequence of L bit positions within the output value, with all other bit positions being set to 0. However, in an alternative implementation the predetermined value could be 1, and in that case the input value would be replicated in a sequence of L bit positions within the output value, with all other bit positions being set to 1.

The techniques described herein can be used in a wide variety of situations where it is desired to perform an effective shift on an input value when producing an output value. In one particular example implementation, such an approach may be used when converting a floating point value into a fixed point value. In particular, whilst a variety of computations may be performed using floating point values, it is often the case that at some point it is desired to convert the floating point value into fixed point form. It is possible to convert any finite floating point number into a wider fixed point number.

In one such example implementation, the input value may be a significand of a floating point value, and the shift indication amount may be an indication of an exponent of the floating point value. The effective shift required of the significand will be dependent on the value of the exponent of the floating point value, and hence the exponent can be used to provide a shift indication amount to the mask generation circuitry in order to cause an appropriate mask to be generated. Furthermore, in such an implementation, the output value may be a fixed point value comprising more bits than are provided by the significand of the floating point value.

The techniques described herein can in principle be applied in association with any floating point format. However, they are particularly beneficially implemented in association with FP8 floating point format, where the relatively constrained range of finite values that can be represented in the floating point format can readily be accommodated within a reasonably sized fixed point number. In one particular example implementation, the technique is used when converting into fixed point form the product generated by multiplying two finite FP8 floating point numbers. Such a product may have a significand that is 8 bits long and the product exponent may be represented by 6 bits. A 6-bit exponent means that the first bit of the product significand can be any of 64 (26) bit positions with the remaining seven bits of the product significand immediately following the first bit, resulting in a 71-bit fixed point number. In actual fact, due to biased FP exponent 0 and 1 representing the same true exponent, and due to the fact that the maximum input exponents do not indicate finite floating point numbers, it is possible to represent any finite FP8 product as a 68-bit fixed point number. Within such an implementation, it is readily possible to generate a mask to implement the required shift functionality, and as a result to significantly reduce the time taken to create the fixed point form representing the earlier-mentioned floating point product, when compared with the use of traditional shift logic components.

As mentioned earlier, the shift indication amount may be derived from an indication of the exponent of the floating point value. In one particular implementation, the indication of the exponent provided for this purpose is the biased exponent used in floating point representations, but in alternative implementations the real exponent value could be used instead.

As mentioned earlier, whilst in some implementations the output value may have more bits than the input value, the techniques can still be used even if this is not the case. For instance, in one example implementation the output value has a same number of bits as the input value. The number of bits used to form the input value and the output value may in one such example implementation also equal the number of bits in the mask, i.e. P=L=N. Alternatively, in some implementations, it may be possible that the number of bits used for both the input value and the output value exceeds the number of bits used for the mask, and in such an application the mask may be repeated in whole or in part to create a larger value.

In one particular example implementation where the output value has the same number of bits as the input value, the shift may be used to implement a rotate such that the output value is a rotated version of the input value.

Particular example implementations of the techniques described herein will now be discussed with reference to the figures.

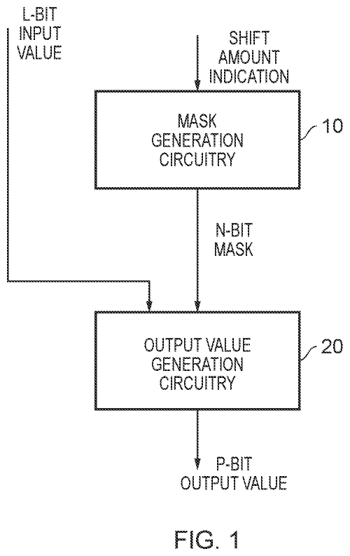

FIG. 1 is a block diagram schematically illustrating an apparatus in accordance with one example implementation, the apparatus being arranged to perform a computation equivalent to applying a shift to an input value to generate an output value. Mask generation circuitry 10 is provided that is arranged to receive a shift amount indication, and based on that shift amount indication is then arranged to generate an N-bit mask, where N is a number of possible bit positions that a given bit of the input value may be located within the output value. The given bit of the input value may be varied dependent on implementation, but in one example implementation is the most significant bit of the input value.

Output value generation circuitry 20 is arranged to receive the N-bit mask produced by the mask generation circuitry, along with the input value, which in the example of FIG. 1 is an L-bit input value. The output value generation circuitry is arranged to apply the N-bit mask to the given bit of the input value in order to determine a corresponding location of the given bit within the output value, in the example of FIG. 1 the output value having P bits. The output value generation circuitry is also arranged to determine a location within the output value of each other bit of the input value in dependence on the corresponding location of the given bit. Hence, in an example implementation where the given bit is the most significant bit, application of the N-bit mask can be used to determine the bit position in the output value in which the most significant bit of the input value should reside. In one example implementation, all of the other bits of the input value will then occupy a series of less significant bit positions within the output value.

By using the above approach, it has been found that the delay associated with applying a shift to an input value can be significantly reduced when compared with the use of conventional shift logic circuits.

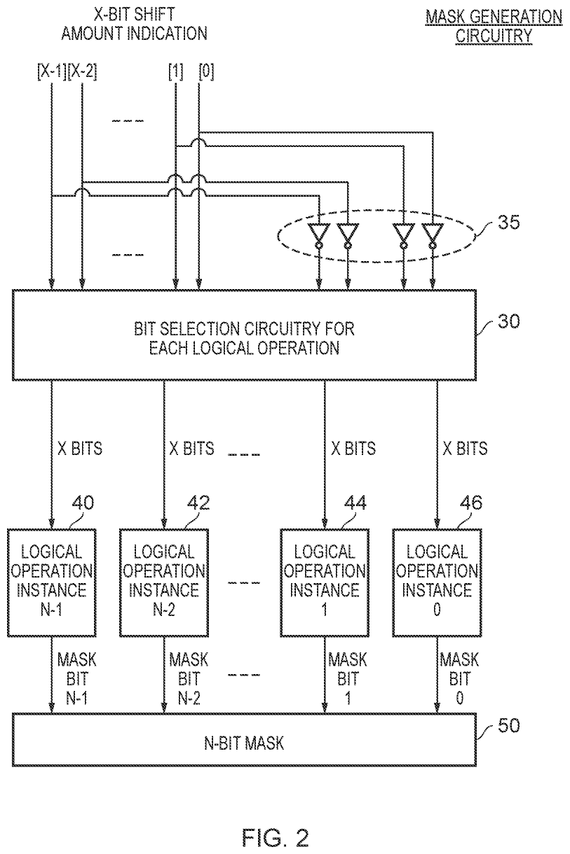

FIG. 2 is a block diagram illustrating in more detail the mask generation circuitry of FIG. 1, in accordance with one example implementation. As shown in FIG. 2, the shift amount indication may be formed of X bits, and those X bits may be provided to bit selection circuitry 30, along with inverted versions of those X bits produced by the inverters 35. The bit selection circuitry is used to determine X bits to be provided as inputs to each of N logical operation instances 40, 42, 44, 46. The bit selection circuitry is arranged to select the X bits provided to each logical operation instance such that each logical operation instance has a different selection of X inputs to any other logical operation instance. In one example implementation, a suitable wiring pattern can be used to route the required X inputs to each logical operation instance and hence no additional logic is required to implement the bit selection circuitry.

Each logical operation instance 40, 42, 44, 46 will comprise logic circuitry used to generate a single corresponding mask bit of the N-bit mask 50 based on the provided X input bits received from the bit selection circuitry 30. Each logical operation instance can perform its associated logical operation independently of the other logical operation instances, with the bit selection circuitry 30 providing each logical operation instance with the relevant X bits to be used as inputs to the logical operation performed by that instance. Hence each of the logical operation instances 40, 42, 44, 46 may, in one example implementation, operate in parallel so that the N bits of the N-bit mask are produced in parallel.

In one example implementation, each logical operation instance 40, 42, 44, 46 is constructed identically to each other instance, but no logical operation instance will receive the same X inputs. The logical operation performed by each logical operation instance is such that, for all combinations of possible values of the X bits forming the shift indication amount, only one of the logical operations will produce a mask bit value that is in the set state. In one example implementation, the set state is indicated by a value of 1, and hence in one example implementation the N-bit mask will have one bit set to 1 with all other bits having a value of 0. However, it will be appreciated that the value used for the set state could in an alternative implementation be a value of 0, and hence in that implementation the N-bit mask will have one bit set to 0 with all other bits having a value of 1.

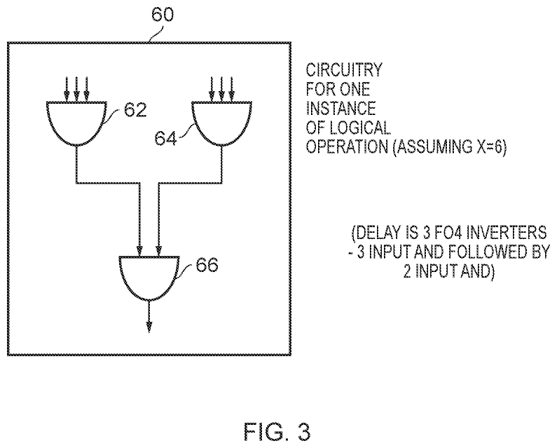

In one example implementation where the set state is indicated by a value of 1, each logical operation instance 40, 42, 44, 46 may be arranged to perform a logical AND of the X bits provided as an input. Only one of the logical operation instances will receive X inputs all having a value of 1, and hence only one of the logical operation instances will produce a mask bit having a value of 1. FIG. 3 illustrates suitable circuitry 60 that may be used for each instance of the logical operation, assuming a specific example case where X=6. As can be seen, two 3-input AND components 62, 64 may be used, each receiving three of the six input bits, and the outputs of those two AND components are then subjected to a further AND operation by the 2-input AND component 66 in order to produce the associated mask bit. Since all of the logical operation instances may be operated in parallel, it will be appreciated that in the specific example shown in FIG. 3 the logical effort required to construct the mask is a 3-input AND followed by a 2-input AND, which has the delay of 3 FO4 inverters. As will be understood by those of ordinary skill in the art, an FO4 (fan-out of 4) is used as a delay metric, and represents the delay of an inverter, driven by an inverter four times smaller than itself, and driving an inverter four times larger than itself.

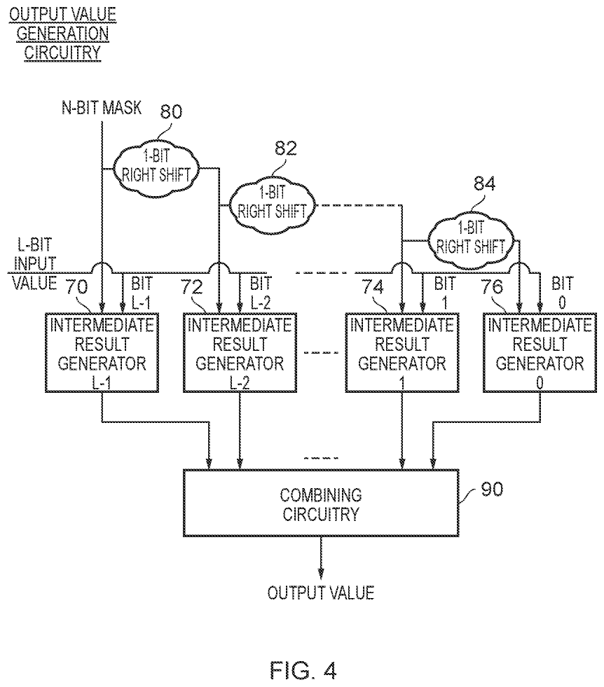

FIG. 4 is a block diagram illustrating in more detail the output value generation circuitry 20 of FIG. 1 in accordance with one example implementation. As shown in FIG. 4, for an L-bit input value L intermediate result generator circuits 70, 72, 74, 76 may be provided, each being arranged to receive an associated bit of the L-bit input value, and a version of the N-bit mask. In one example implementation, the N-bit mask is generated for use in association with the most significant bit of the L-bit input value, and is provided to the intermediate result generator 70 along with the most significant bit (i.e. bit L−1) of the input value. As shown by the bubbles 80, 82, 84, a logical one-bit right shift of the N-bit mask can be repetitively performed for each subsequent least significant bit of the input value, with the relevant shifted version of the mask being provided to an associated intermediate result generator along with a corresponding associated bit of the input value. Hence, by way of example, the intermediate result generator 72 receives the second most significant bit (i.e. bit L−2) of the input value, along with a one-bit right shifted version of the N-bit mask. Similarly, the intermediate result generator 74 will receive an L−2 right shifted version of the N-bit mask and bit 1 of the input value. Finally, the intermediate result generator 76 will receive an L−1 right-shifted version of the N-bit mask and bit 0 (i.e. the least significant bit) of the input value.

Whilst the required one-bit right shifts 80, 82, 84 could be performed in a variety of ways, in one particular example implementation the effective shifting of the mask is achieved merely by appropriate rewiring of the N-bit mask. Hence, no additional logic is required in order to generate each shifted version of the N-bit mask, and instead simple wiring patterns can be used to move the N-bit mask to align it appropriately for use by each intermediate result generator 70, 72, 74, 76.

Each intermediate result generator 70, 72, 74, 76 is arranged to determine, based on the provided version of the mask, the appropriate bit position within the output value that the associated bit of the input value provided to that intermediate result generator should reside within. In one particular example implementation, this is achieved by replicating the provided bit of the input value N times and then logically combining it with the provided version of the mask to propagate the input bit value into the bit position of an intermediate result that corresponds with the appropriate bit position within the output value. In particular, each version of the mask used will only have one bit position in the set state, and that bit position can be used to propagate the relevant bit of the input value into the bit position of the intermediate result that corresponds with the appropriate bit position within the output value. Combining circuitry 90 can then be used to combine the various intermediate results in order to generate an output value where each bit of the input value is at the correct location within the output value taking into account the desired shift indicated by the shift amount indication that was used to generate the mask.

As noted earlier, the output value may in one example implementation comprise P bits, and in one particular example implementation P is greater than N. In such an implementation, each intermediate result generator 70, 72, 74, 76 may be arranged to generate its intermediate result such that the intermediate result includes P-N padding bit values provided in at least one of most significant bit positions and least significant bit positions of the intermediate result. In the example illustrated in FIG. 4, the intermediate result generator 70 (which as discussed earlier is operating on the most significant bit of the input value) will produce an intermediate result that includes P-N padding bits in least significant bit positions of the intermediate result. The intermediate result generated for each successive less significant bit of the input value then has one more padding bit in the most significant bit positions than the intermediate result generated for an adjacent more significant bit of the input value. Hence, purely by way of example, the intermediate result generated by the intermediate result generator 72 will have one padding bit in the most significant bit position, followed by N bits generated by application of the mask, followed by P-N−1 padding bits.

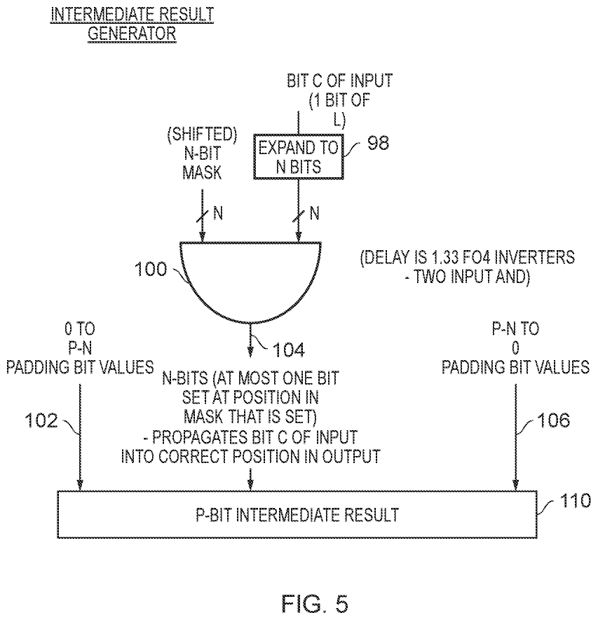

This is illustrated schematically in FIG. 5, which shows one example of the intermediate result generator. The intermediate result generator in this example takes the form of AND circuitry 100 used to perform a logical AND operation using as inputs the provided version of the N-bit mask, and an N-bit value produced by the expansion circuitry 98 replicating a single bit (bit C) of the input value. The output 104 from the AND circuitry 100 is N-bits, with at most one bit set at the position in the mask that was set (whether that bit is in fact set will depend on whether bit C had a value of 1 or a value of 0). A suitable number of padding bits 102, 106 are then added to either or both sides of the output 104 from the AND circuitry 100 in order to produce a P-bit intermediate result 110, where bit C of the input has been propagated into the correct position within the P bit positions that will be used for the output value. From FIG. 5, it will be appreciated that the delay associated with forming an intermediate result is the delay incurred by the two input AND gate circuitry 100, which has the delay of 1.33 FO4 inverters. Since the intermediate results can be produced in parallel, and the shifted versions of the N-bit mask used by the various intermediate result generators can be obtained merely by suitable rewiring (hence requiring no additional logic), then no additional delay is incurred in generating all of the intermediate results.

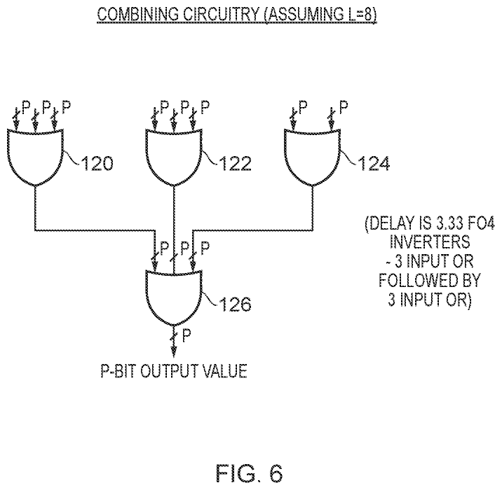

Once the various intermediate results have been generated in the above manner, then the combining circuitry 90 can be arranged to logically combine the various individual intermediate results to form a final output value. In one example implementation, a logical OR operation is performed to combine the various intermediate results to form the output value. FIG. 6 illustrates suitable circuitry that may be used to form the combining circuitry, for a specific example case where the size of the input value is 8 bits, and hence L=8. As a result, it will be appreciated from the earlier discussion of FIG. 4 that there will be 8 intermediate results produced which need to be combined by the combining circuitry. In the example shown in FIG. 6, this is achieved by using a first level of OR gate circuits 120, 122, 124, followed by a final level OR gate circuit 126 to combine the outputs from each of the OR gate circuits at the first level. Hence, the additional logical effort required to perform the combining of the intermediate results equates to the cost of two 3-input OR gates, which has the delay of 3.33 FO4 inverters. Thus, the total delay cost to produce the output value, assuming the specific example circuitry of FIGS. 3, 5 and 6 are used, is hence 7.66 (3+1.33+3.33) FO4 inverters, which is significantly less than the delay that would be incurred were standard shift logic circuits used (which in one example would be 12 FO4 delays).

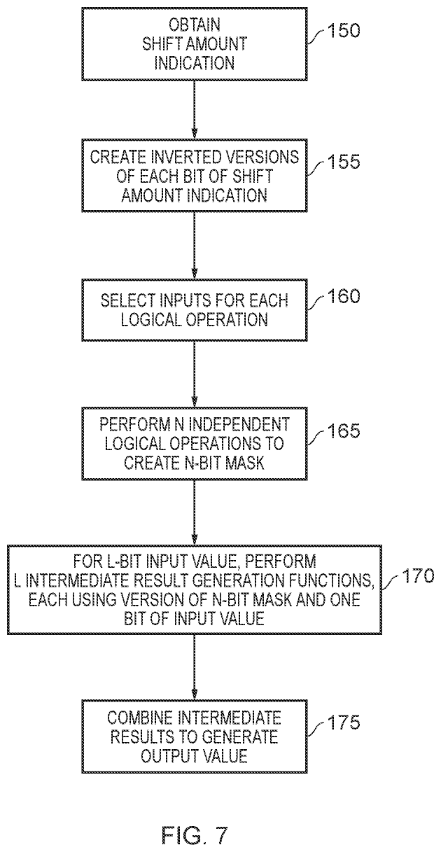

FIG. 7 is a flow diagram illustrating the steps performed in one example implementation in order to generate an output value representing a shifted input value. At step 150, a shift amount indication is obtained indicative of the amount of shift required. At step 155, inverted versions of each bit of the shift amount indication are created, for example using the inverters 35 discussed earlier with reference to FIG. 2. Then, at step 160 the inputs for each logical operation are selected, for example using the bit selection circuitry 30 discussed earlier with reference to FIG. 2.

At step 165, N independent logical operations are performed (for example using the logical operation instances 40, 42, 44, 46 discussed earlier with reference to FIG. 2) in order to create an N-bit mask, each logical operation being provided with the inputs for that logical operation determined at step 160.

At step 170, for an L-bit input value L intermediate result generation functions are performed, each using a version of the N-bit mask and one bit of the input value. This step can for example be performed using the intermediate result generator circuits 70, 72, 74, 76 discussed earlier with reference to FIG. 4. Then, at step 175, the various intermediate results are combined in order to generate an output value, using for example the combining circuitry 90 discussed earlier with reference to FIG. 4.

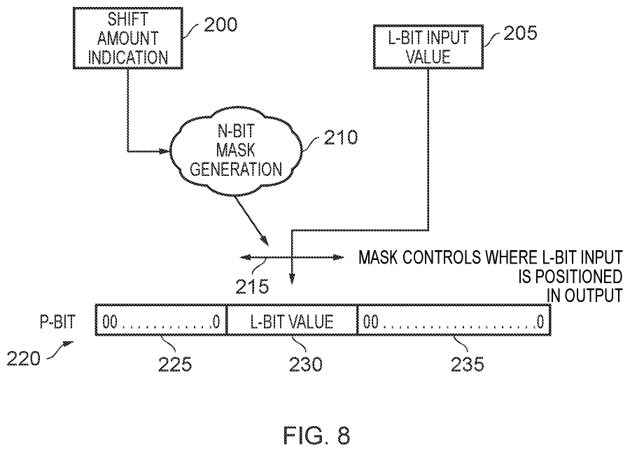

FIG. 8 schematically illustrates how a mask may be applied to an input value in order to perform a computation equivalent to a shift when generating an output value, in accordance with one example implementation. As will be apparent from the earlier discussion, a shift amount indication 200 can be provided as an input to a mask generation function 210 which can then generate an N-bit mask, where N is a number of possible bit positions that a given bit (for example a most significant bit) of an L-bit input value 205 may be located within a P-bit output value 220 after the shift is performed. The N-bit mask can then be used to position that given bit of the input value at an appropriate position within the P-bit output value, with the same mask also being reused as discussed earlier (albeit in logically shifted form) to position within the output value each of the remaining bits of the input value. Hence, as schematically shown by the double ended arrow 215 in FIG. 8, the mask can be used to effectively control where the L-bit input is positioned within the P-bit output. In the illustration shown, the L-bit value is positioned in the region 230 of the output value 220, with a certain number of padding bits 225, 235 being provided in most significant and least significant bit positions of the P-bit output value. As discussed earlier, whilst in the example shown there are padding bits in both regions 225 and 235, in some instances there may be no padding bits in most significant bit positions or indeed may be no padding bits in least significant bit positions, depending on where the L-bit input value is positioned within the output value in dependence on the N-bit mask.

The techniques described herein can be used in a wide variety of situations where it is desired to perform an effective shift on an input value when producing an output value. However, as noted earlier, in one particular example implementation such an approach may be used when converting a floating point value into a fixed point value. The following discussion of floating point numbers is provided by way of background.

Floating-point (FP) is a useful way of approximating real numbers using a small number of bits. The IEEE 754-2008 F P Standard proposes multiple different formats for FP numbers, for example binary 64 (also known as double precision, or DP), binary 32 (also known as single precision, or SP), and binary 16 (also known as half precision, or HP). The numbers 64, 32, and 16 refer to the number of bits required for each format.

FP numbers are quite similar to the “scientific notation” taught in science classes, where instead of negative two million one would write −2.0×10⁶. The parts of this number are the sign (in this case negative), the significand (2.0), the base of the exponent (10), and the exponent (6). All of these parts have analogs in FP numbers, although there are differences, the most important of which is that the constituent parts are stored as binary numbers, and the base of the exponent is always 2.

More precisely, FP numbers all consist of a sign bit, some number of biased exponent bits, and some number of fraction bits. In particular, the above-mentioned formats consist of the following bits:

| format | sign | exponent | fraction | exponent bias |
|---|---|---|---|---|
| DP [63:0] | 63 | 62:52 (11 bits) | 51:0 (52 bits) | 1023 |
| SP [31:0] | 31 | 30:23 (8 bits) | 22:0 (23 bits) | 127 |
| HP [15:0] | 15 | 14:10 (5 bits) | 9:0 (10 bits) | 15 |

The sign is 1 for negative numbers and 0 for positive numbers. Every number, including zero, has a sign.

The exponent is biased, which means that the true exponent differs from the one stored in the number. For example, biased SP exponents are 8-bits long and range from 0 to 255. Exponents 0 and 255 are special cases, but all other exponents have bias 127, meaning that the true exponent is 127 less than the biased exponent. The smallest biased exponent is 1, which corresponds to a true exponent of −126. The maximum biased exponent is 254, which corresponds to a true exponent of 127. HP and DP exponents work the same way, with the biases indicated in the table above.

SP exponent 255 (or DP exponent 2047, or HP exponent 31) is reserved for infinities and special symbols called NaNs (not a number). Infinities (which can be positive or negative) have a zero fraction. Any number with exponent 255 and a non-zero fraction is a NaN. Infinity provides a saturation value, so it actually means something like “this computation resulted in a number that is bigger than what we can represent in this format.” NaNs are returned for operations that are not mathematically defined on the real numbers, for example dividing zero by zero or taking the square root of a negative number.

Exponent zero, in any of the formats, is reserved for subnormal numbers and zeros. A normal number represents the value:
−1^{sign}×1.fraction×2^{e}
where e is the true exponent computed from the biased exponent. The term 1.fraction is called the significand, and the 1 is not stored as part of the FP number, but is instead inferred from the exponent. All exponents except zero and the maximum exponent indicate a significand of the form 1.fraction. The exponent zero indicates a significand of the form 0.fraction, and a true exponent that is equal to 1-bias for the given format. Such a number is called subnormal (historically these numbers were referred to as denormal, but modern usage prefers the term subnormal).

Numbers with both exponent and fraction equal to zero are zeros.

The following table has some example numbers in HP format. The entries are in binary, with ‘_’ characters added to increase readability. Notice that the subnormal entry (4th line of the table, with zero exponent) produces a different significand than the normal entry in the preceding line.

| | 5-bit | | | |
|---|---|---|---|---|
| sign | exponent | 10-bit fraction | 11-bit significand | value |
| 0 | 01111 | 00_0000_0000 | 100_0000_0000 | 1.0 × 2⁰ |
| 1 | 01110 | 10_0000_0000 | 110_0000_0000 | −1.1 × 2⁻¹ |
| 0 | 00001 | 10_0000_0000 | 110_0000_0000 | 1.1 × 2⁻¹⁴ |
| 0 | 00000 | 10_0000_0000 | 010_0000_0000 | 0.1 × 2⁻¹⁴ |
| 1 | 11111 | 00_0000_0000 | | −infinity |
| 0 | 11111 | 00_1111_0011 | | NaN |

The FP way of handling signs is called sign-magnitude, and it is different from the usual way integers are stored in a computer (two's complement). In sign-magnitude representation, the positive and negative versions of the same number differ only in the sign bit. A 4-bit sign-magnitude integer, consisting of a sign bit and 3 significand bits, would represent plus and minus one as:
+1=0001
−1=1001

In two's complement representation, an n-bit integer i is represented by the low order n bits of the binary n+1-bit value 2ⁿ+i, so a 4-bit two's complement integer would represent plus and minus one as:
+1=0001
−1=1111

The two's complement format is practically universal for signed integers because it simplifies computer arithmetic.

A fixed-point number looks exactly like an integer, but actually represents a value that has a certain number of fractional bits. Sensor data is often in fixed-point format, and there is a great deal of fixed-point software that was written before the widespread adoption of FP. Fixed-point numbers are quite tedious to work with because a programmer has to keep track of the “binary point”, i.e. the separator between the integer and fractional parts of the number, and also has to constantly shift the number to keep the bits in the correct place. FP numbers don't have this difficulty, so it is desirable to be able to convert between fixed-point numbers and FP numbers. Being able to do conversions also means that we can still use fixed-point software and data, but we are not limited to fixed-point when writing new software.

More recently newer formats of floating point numbers have been developed, for example:

| format | sign | exponent | fraction | exponent bias |
|---|---|---|---|---|
| bfloat[15:0] | 15 | 14:7 (8 bits) | 6:0 (7 bits) | 127 |
| FP8 1-5-2 [7:0] | 7 | 6:2 (5 bits) | 1:0 (2 bits) | 15 |
| FP8 1-4-3 [7:0] | 7 | 6:3 (4 bits) | 2:0 (3 bits) | 7 |

These continue to follow the IEEE exponent biasing rules, where an n-bit exponent 0<e<2ⁿ−1 has bias 2ⁿ⁻¹−1 and exponent zero is for subnormals and zeros. For most formats the exponent 2ⁿ−1 is for infinities and NaNs, but the 1-4-3 format is likely to use the maximum exponent for biased numerical values.

It has been realised that it may be useful to use the FP8 formats as storage formats. This does not mean that they can't be used in computations, but that they tend not to be intermediate or final results of computations, just inputs to computations. The most common computation in machine learning is matrix multiplication, where each entry of the product matrix is computed as a sum of many products.

Some particular computations that may be usefully performed are a sum of an SP value with four FP8 products, and a sum of an HP value with two FP8 products.

The FP8 inputs can be any combination of the two FP8 formats. A suitable way to handle this is to convert any FP8 inputs to a hybrid 1-5-3 format. Conversion from 4-bit exponents to 5-bit exponents can be performed as follows.

Let e be the true exponent, let e_4b be the biased 4-bit exponent, and let e_5b be corresponding biased 5-bit exponent. The way biasing works we have e_4b=e+7, and e_5b=e+15. The underlying true exponent e does not change, which makes converting from 4 to 5 bit exponents straightforward: e_4b-7=e_5b−15, or e_5b=e_4b+8. Adding 8 to a 4-bit exponent does not require an adder:
assign e_5b[4:0]={e_4b[3], ˜e_4b[3], e_4b[2:0]};

Hence, converting to a common 5-bit biased exponent involves hardly any gates, just one inverter.

It is necessary to deal with zero exponents, and for computing shift distances they are best treated as exponent 1 (because biased exponents zero and one represent the same real exponent). Infinities and NaNs are handled outside of the normal exponent computations.

As usual, the product of two numbers with true 5-bit exponents ea and eb has exponent ea+eb. For most multipliers the computation is not that simple because the sum of two biased exponents gives an exponent that has twice the bias: ea_5b+eb_5b=ea+15+eb+15=ea+eb+30. When using the technique describe herein to convert each product to a fixed point number, it would be convenient to use a 6-bit biased exponent for the sum. By the IEEE exponent biasing convention, a 6-bit biased exponent would have bias 31. It has already been shown above that the sum of the two biased 5-bit exponents has bias 30, so the correct bias can readily be achieved by adding a carry-in bit to the sum of the exponents:
assign e_6b[5:0]=ea_5b[4:0]+eb_5b[4:0]+1′b1;

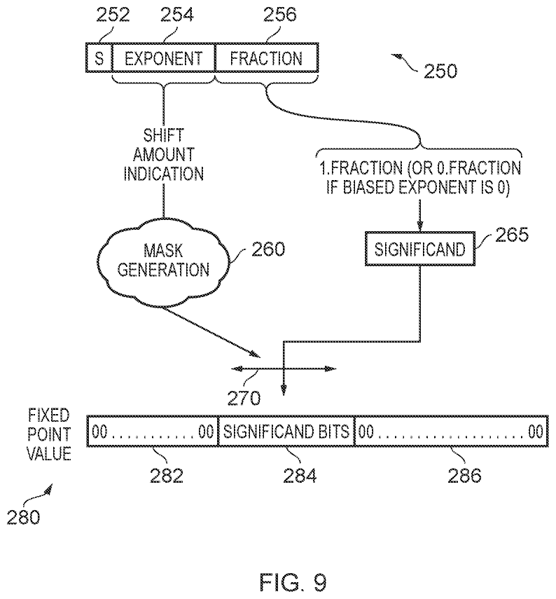

As discussed earlier, when using the techniques described herein to convert a floating point value into a fixed point value, the input value can take the form of the significand of the floating point value, and the shift indication amount may be an indication of an exponent of the floating point value. FIG. 9 schematically illustrates the use of the technique described herein in association with the conversion of a floating point value into a fixed point value. From the above discussion, it will be appreciated that the floating point value 250 will consist of a sign bit 252, a biased exponent 254 and a fraction 256. The significand 265 for a finite floating point value is equal to “1.fraction” in normal cases (or as discussed earlier is 0.fraction if the biased exponent is 0). As noted above, the exponent can be used to provide the shift amount indication that is input to the mask generation function 260, and in one particular example implementation the biased exponent 254 is used for this purpose. In an analogous way to that discussed earlier with reference to FIG. 8, the mask can be used to place the significand 265 at an appropriate location within the fixed point value 280 taking into account the exponent. As shown schematically in FIG. 9, the region 284 may hence accommodate the significand bits, with the exact placement of that region being dependent on the mask, as indicated by the double ended arrow 270, and padding bits may be added in the regions 282 and/or 286 as needed. The representation 280 of the fixed point value as shown in FIG. 9 is correct if the floating point number is a positive number. However, if the floating point number is a negative number, as indicated by the sign bit 252, then due to the fact that fixed point numbers are two's complement numbers (as opposed to floating point numbers which are sign-magnitude numbers) all of the bits of the representation 280 would be inverted, and then 1 added, in order to produce the final fixed point value.

In one particular example implementation, the techniques described herein are used when converting into fixed point form the product generated by multiplying two finite FP8 floating point numbers. Such a product may have a significand that is 8 bits long and the product exponent may be represented by 6 bits. A 6-bit exponent means that the first bit of the product significand can be any of 64 (26) bit positions with the remaining seven bits of the product significand immediately following the first bit, resulting in a 71-bit fixed point number. In actual fact, due to biased FP exponent 0 and 1 representing the same true exponent, and due to the fact that the maximum input exponents do not indicate finite floating point numbers, it is possible to represent any finite FP8 product as a 68-bit fixed point number. Within such an implementation, it is ready possible to generate a 64-bit mask to implement the required shift functionality, and the following illustrates how the biased exponent bits may be used as inputs to the logical operations used to produce each bit of the mask:

```
// assign fm[63] = e[5] & e[4] & e[3] & e[2] & e[1] & e[0]; // infinity or
NaN input
// assign fm[62] = e[5] & e[4] & e[3] & e[2] & e[1] & ~e[0]; // infinity or
NaN input
  assign fm[61] = e[5] & e[4] & e[3] & e[2] & ~e[1] & e[0];
  assign fm[60] = e[5] & e[4] & e[3] & e[2] & ~e[1] & ~e[0];
  assign fm[59] = e[5] & e[4] & e[3] & ~e[2] & e[1] & e[0];
  assign fm[58] = e[5] & e[4] & e[3] & ~e[2] & e[1] & ~e[0];
  assign fm[57] = e[5] & e[4] & e[3] & ~e[2] & ~e[1] & e[0];
  assign fm[56] = e[5] & e[4] & e[3] & ~e[2] & ~e[1] & ~e[0];
  assign fm[55] = e[5] & e[4] & ~e[3] & e[2] & e[1] & e[0];
  assign fm[54] = e[5] & e[4] & ~e[3] & e[2] & e[1] & ~e[0];
  assign fm[53] = e[5] & e[4] & ~e[3] & e[2] & ~e[1] & e[0];
  assign fm[52] = e[5] & e[4] & ~e[3] & e[2] & ~e[1] & ~e[0];
  assign fm[51] = e[5] & e[4] & ~e[3] & ~e[2] & e[1] & e[0];
  assign fm[50] = e[5] & e[4] & ~e[3] & ~e[2] & e[1] & ~e[0];
  assign fm[49] = e[5] & e[4] & ~e[3] & ~e[2] & ~e[1] & e[0];
  assign fm[48] = e[5] & e[4] & ~e[3] & ~e[2] & ~e[1] & ~e[0];
  assign fm[47] = e[5] & ~e[4] & e[3] & e[2] & e[1] & e[0];
  assign fm[46] = e[5] & ~e[4] & e[3] & e[2] & e[1] & ~e[0];
  assign fm[45] = e[5] & ~e[4] & e[3] & e[2] & ~e[1] & e[0];
  assign fm[44] = e[5] & ~e[4] & e[3] & e[2] & ~e[1] & ~e[0];
  assign fm[43] = e[5] & ~e[4] & e[3] & ~e[2] & e[1] & e[0];
  assign fm[42] = e[5] & ~e[4] & e[3] & ~e[2] & e[1] & ~e[0];
  assign fm[41] = e[5] & ~e[4] & e[3] & ~e[2] & ~e[1] & e[0];
  assign fm[40] = e[5] & ~e[4] & e[3] & ~e[2] & ~e[1] & ~e[0];
  assign fm[39] = e[5] & ~e[4] & ~e[3] & e[2] & e[1] & e[0];
  assign fm[38] = e[5] & ~e[4] & ~e[3] & e[2] & e[1] & ~e[0];
  assign fm[37] = e[5] & ~e[4] & ~e[3] & e[2] & ~e[1] & e[0];
  assign fm[36] = e[5] & ~e[4] & ~e[3] & e[2] & ~e[1] & ~e[0];
  assign fm[35] = e[5] & ~e[4] & ~e[3] & ~e[2] & e[1] & e[0];
  assign fm[34] = e[5] & ~e[4] & ~e[3] & ~e[2] & e[1] & ~e[0];
  assign fm[33] = e[5] & ~e[4] & ~e[3] & ~e[2] & ~e[1] & e[0];
  assign fm[32] = e[5] & ~e[4] & ~e[3] & ~e[2] & ~e[1] & ~e[0];
  assign fm[31] = ~e[5] & e[4] & e[3] & e[2] & e[1] & e[0];
  assign fm[30] = ~e[5] & e[4] & e[3] & e[2] & e[1] & ~e[0];
  assign fm[29] = ~e[5] & e[4] & e[3] & e[2] & ~e[1] & e[0];
  assign fm[28] = ~e[5] & e[4] & e[3] & e[2] & ~e[1] & ~e[0];
  assign fm[27] = ~e[5] & e[4] & e[3] & ~e[2] & e[1] & e[0];
  assign fm[26] = ~e[5] & e[4] & e[3] & ~e[2] & e[1] & ~e[0];
  assign fm[25] = ~e[5] & e[4] & e[3] & ~e[2] & ~e[1] & e[0];
  assign fm[24] = ~e[5] & e[4] & e[3] & ~e[2] & ~e[1] & ~e[0];
  assign fm[23] = ~e[5] & e[4] & ~e[3] & e[2] & e[1] & e[0];
  assign fm[22] = ~e[5] & e[4] & ~e[3] & e[2] & e[1] & ~e[0];
  assign fm[21] = ~e[5] & e[4] & ~e[3] & e[2] & ~e[1] & e[0];
  assign fm[20] = ~e[5] & e[4] & ~e[3] & e[2] & ~e[1] & ~e[0];
  assign fm[19] = ~e[5] & e[4] & ~e[3] & ~e[2] & e[1] & e[0];
  assign fm[18] = ~e[5] & e[4] & ~e[3] & ~e[2] & e[1] & ~e[0];
  assign fm[17] = ~e[5] & e[4] & ~e[3] & ~e[2] & ~e[1] & e[0];
  assign fm[16] = ~e[5] & e[4] & ~e[3] & ~e[2] & ~e[1] & ~e[0];
  assign fm[15] = ~e[5] & ~e[4] & e[3] & e[2] & e[1] & e[0];
  assign fm[14] = ~e[5] & ~e[4] & e[3] & e[2] & e[1] & ~e[0];
  assign fm[13] = ~e[5] & ~e[4] & e[3] & e[2] & ~e[1] & e[0];
  assign fm[12] = ~e[5] & ~e[4] & e[3] & e[2] & ~e[1] & ~e[0];
  assign fm[11] = ~e[5] & ~e[4] & e[3] & ~e[2] & e[1] & e[0];
  assign fm[10] = ~e[5] & ~e[4] & e[3] & ~e[2] & e[1] & ~e[0];
  assign fm[9] = ~e[5] & ~e[4] & e[3] & ~e[2] & ~e[1] & e[0];
  assign fm[8] = ~e[5] & ~e[4] & e[3] & ~e[2] & ~e[1] & ~e[0];
  assign fm[7] = ~e[5] & ~e[4] & ~e[3] & e[2] & e[1] & e[0];
  assign fm[6] = ~e[5] & ~e[4] & ~e[3] & e[2] & e[1] & ~e[0];
  assign fm[5] = ~e[5] & ~e[4] & ~e[3] & e[2] & ~e[1] & e[0];
  assign fm[4] = ~e[5] & ~e[4] & ~e[3] & e[2] & ~e[1] & ~e[0];
  assign fm[3] = ~e[5] & ~e[4] & ~e[3] & ~e[2] & e[1] & e[0];
  assign fm[2] = ~e[5] & ~e[4] & ~e[3] & ~e[2] & e[1] & ~e[0];
  assign fm[1] = ~e[5] & ~e[4] & ~e[3] & ~e[2] & ~e[1]; // exponents zero and one
have the same first significand bit
  // assign fm[0] = ~e[5] & ~e[4] & ~e[3] & ~e[2] & ~e[1] & ~e[0];
```

As will be apparent from the above discussion, using the mask, an intermediate result can be generated for each of the bits of the input value, which as discussed above will in this case be an 8-bit significand. Hence eight intermediate results will be generated, which can then be combined by a logical OR operation to generate the final 68-bit fixed point representation. This can be illustrated as follows:

// product bits p[7:0] moved to their correct locations as fixed-point numbers
// we only compute the location of the first product bit, because the others
// have a fixed location with respect to that first bit.

| assign fp[67:0] = ({ {fm[61:1]} & {61{p[7]}}, {7{1′b0}}}) | | // first bit |
|---|---|---|
| | \| ({1′b0, {fm[61:1]} & {61{p[6]}}, {6{1′b0}}}) | // second bit |
| | \| ({{2{1′b0}}, {fm[61:1]} & {61{p[5]}}, {5{1′b0}}}) | // third bit |
| | \| ({{3{1′b0}}, {fm[61:1]} & {61{p[4]}}, {4{1′b0}}}) | // |
| | \| ({{4{1′b0}}, {fm[61:1]} & {61{p[3]}}, {3{1′b0}}}) | // |
| | \| ({{5{1′b0}}, {fm[61:1]} & {61{p[2]}}, {2{1′b0}}}) | // |
| | \| ({{6{1′b0}}, {fm[61:1]} & {61{p[1]}}, {1{1′b0}}}) | // |
| | \| ({{7{1′b0}}, {fm[61:1]} & {61{p[0]}} }); | // last bit |

Whilst in the above example the output value has more bits than the input value, the techniques described herein can still be used even if this is not the case. For instance, in one example implementation the output value may have the same number of bits as the input value. The number of bits used to form the input value and the output value may in one such example implementation also equal the number of bits in the mask, i.e. P=L=N. Alternatively, in some implementations, it may be possible that the number of bits used for both the input value and the output value exceeds the number of bits used for the mask, and in such an application the mask may be repeated in whole or in part to create a larger value.

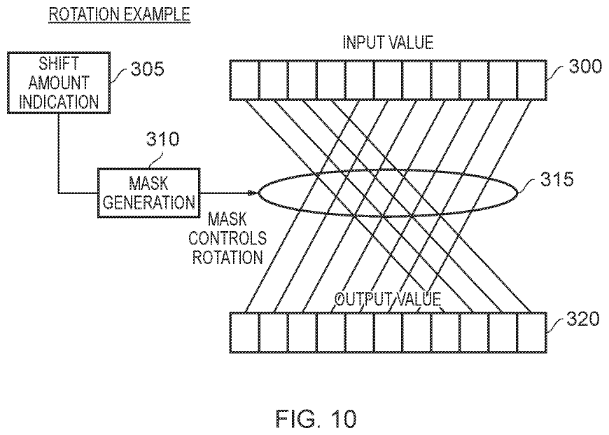

In one particular example implementation where the output value has the same number of bits as the input value, the shift may be used to implement a rotate such that the output value is a rotated version of the input value, as illustrated schematically in FIG. 10. As shown, a shift amount indication 305 is input to the mask generation function 310 in order to generate a mask. The mask is then applied to the input value 300 in order to perform the rotation schematically illustrated by the reference numeral 315 in order to produce the output value 320.

Hence, it can be seen that the techniques described herein have a wide variety of applications, and can significantly improve performance by reducing the delay associated with performing shifts on data values.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

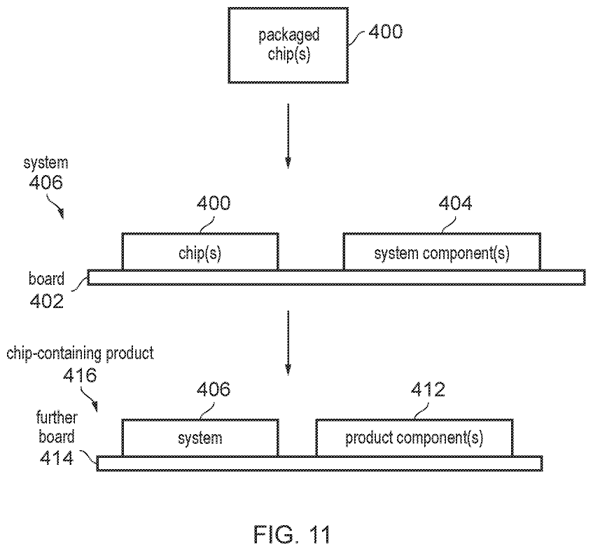

As shown in FIG. 11, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some example configurations are set out in the following numbered clauses:

1. An apparatus to perform a computation equivalent to applying a shift to an input value to generate an output value, comprising:
mask generation circuitry to generate an N-bit mask in dependence on a provided shift amount indication, where N is a number of possible bit positions that a given bit of the input value may be located within the output value after the shift is performed, wherein the mask generation circuitry is arranged to perform N independent logical operations on bits forming the shift amount indication, each logical operation producing a mask bit value for a corresponding bit position of the N-bit mask, and the N logical operations being arranged such that, for any given shift amount indication, only one bit position in the generated N-bit mask will have its mask bit value indicating a set state; and
output value generation circuitry to apply the N-bit mask to the given bit of the input value in order to determine a corresponding location of the given bit within the output value, and to determine a location within the output value of each other bit of the input value in dependence on the corresponding location of the given bit.

2. An apparatus as in Clause 1, wherein the shift indication amount is an X-bit value, and each logical operation uses X inputs chosen from non-inverted and inverted versions of each bit of the shift indication amount, such that each logical operation has a different X inputs to any other logical operation of the N logical operations.

3. An apparatus as in Clause 2, wherein each logical operation is arranged to perform a logical AND of the X inputs provided for that that logical operation.

4. An apparatus as in any preceding clause, wherein:
the output value comprises at least N bits;
the output value generation circuitry is arranged to align the N-bit mask with N bit positions of the output value such the corresponding location of the given bit within the output value is identified by the one bit position in the generated N-bit mask that has the mask bit value indicating the set state.

5. An apparatus as in Clause 4, wherein the output value generation circuitry is arranged to apply a shifted version of the N-bit mask to each other bit of the input value other than the given bit in order to determine a corresponding location of each other bit within the output value, where for any selected other bit of the input value the shifted version of the N-bit mask is arranged to adjust for a number of bit positions between the given bit and the selected other bit.

6. An apparatus as in Clause 5, wherein application of the shifted version of the N-bit mask is achieved by rewiring of the N-bit mask.

7. An apparatus as in Clause 5 or Clause 6, wherein a given shifted version of the N-bit mask used for a given other bit of the input value comprises the N-bit mask aligned with N bit positions of the output value such the corresponding location of the given other bit within the output value is identified by the one bit position in the given shifted version of the N-bit mask that has the mask bit value indicating the set state.

8. An apparatus as in any of clauses 5 to 7, wherein the input value comprises L bits, and L−1 shifted versions of the N-bit mask are formed, each shifted version being associated with one of the L−1 other bits of the input value.

9. An apparatus as in Clause 8, wherein the output value generation circuitry is arranged to generate L intermediate results, each intermediate result being generated by applying a version of the N-bit mask to its associated bit of the input value, and the output value generation circuitry comprises combining circuitry to logically combine the L intermediate results to generate the output value.

10. An apparatus as in Clause 9, wherein the output value has P bits, where P is greater than N, and each intermediate result includes P-N padding bit values provided in at least one of most significant bit positions and least significant bit positions of the intermediate result.

11. An apparatus as in Clause 10, wherein the given bit is the most significant bit of the input value, the intermediate result generated by applying the N-bit mask to the given bit has padding bits provided in the P-N least significant bit positions, and the intermediate result generated for each successive less significant bit of the input value has one more padding bit in the most significant bit positions than the intermediate result generated for an adjacent more significant bit of the input value.

12. An apparatus as in any preceding clause, wherein the output value has more bits than the input value, the input value comprises L bits, and the output value generation circuitry is arranged to apply the N-bit mask so as to replicate the input value in a sequence of L bit positions within the output value.

13. An apparatus as in Clause 12, wherein the output value generation circuitry is arranged to generate the output value such that each bit position other than the L bit positions has its value set to a predetermined value.

14. An apparatus as in any preceding clause, wherein the input value is a significand of a floating point value, and the shift indication amount is an indication of an exponent of the floating point value.

15. An apparatus as in Clause 14, wherein the output value is a fixed point value comprising more bits than are provided by the significand of the floating point value.

16. An apparatus as in any of clauses 1 to 11, wherein the output value has a same number of bits as the input value.

17. An apparatus as in Clause 16, wherein the shift implements a rotate such that the output value is a rotated version of the input value.

18. A system comprising:
the apparatus of any preceding clause, implemented in at least one packaged chip;
at least one system component; and
a board,
wherein the at least one packaged chip and the at least one system component are assembled on the board.

19. A chip-containing product comprising the system of Clause 18 assembled on a further board with at least one other product component.

20. A computer-readable medium to store computer-readable code for fabrication of the apparatus of any of clauses 1 to 17.

21. A method of performing a computation equivalent to applying a shift to an input value to generate an output value, comprising:
employing mask generation circuitry to generate an N-bit mask in dependence on a provided shift amount indication, where N is a number of possible bit positions that a given bit of the input value may be located within the output value after the shift is performed, the mask generation circuitry performing N independent logical operations on bits forming the shift amount indication, each logical operation producing a mask bit value for a corresponding bit position of the N-bit mask, and the N logical operations being arranged such that, for any given shift amount indication, only one bit position in the generated N-bit mask will have its mask bit value indicating a set state; and
applying the N-bit mask to the given bit of the input value in order to determine a corresponding location of the given bit within the output value, and determining a location within the output value of each other bit of the input value in dependence on the corresponding location of the given bit.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus to perform a computation equivalent to applying a shift to an input value to generate an output value, comprising:
mask generation circuitry to generate an N-bit mask in dependence on a provided shift amount indication, where N is a number of possible bit positions that a given bit of the input value may be located within the output value after the shift is performed, wherein the mask generation circuitry is arranged to perform N independent logical operations on bits forming the shift amount indication, each logical operation producing a mask bit value for a corresponding bit position of the N-bit mask, and the N logical operations being arranged such that, for any given shift amount indication, only one bit position in the generated N-bit mask will have its mask bit value indicating a set state; and
output value generation circuitry to apply the N-bit mask to the given bit of the input value in order to determine a corresponding location of the given bit within the output value, and to determine a location within the output value of each other bit of the input value in dependence on the corresponding location of the given bit.

2. An apparatus as claimed in claim 1, wherein the shift indication amount is an X-bit value, and each logical operation uses X inputs chosen from non-inverted and inverted versions of each bit of the shift indication amount, such that each logical operation has a different X inputs to any other logical operation of the N logical operations.

3. An apparatus as claimed in claim 2, wherein each logical operation is arranged to perform a logical AND of the X inputs provided for that that logical operation.

4. An apparatus as claimed in claim 1, wherein:
the output value comprises at least N bits;
the output value generation circuitry is arranged to align the N-bit mask with N bit positions of the output value such the corresponding location of the given bit within the output value is identified by the one bit position in the generated N-bit mask that has the mask bit value indicating the set state.

5. An apparatus as claimed in claim 4, wherein the output value generation circuitry is arranged to apply a shifted version of the N-bit mask to each other bit of the input value other than the given bit in order to determine a corresponding location of each other bit within the output value, where for any selected other bit of the input value the shifted version of the N-bit mask is arranged to adjust for a number of bit positions between the given bit and the selected other bit.

6. An apparatus as claimed in claim 5, wherein application of the shifted version of the N-bit mask is achieved by rewiring of the N-bit mask.

7. An apparatus as claimed in claim 5, wherein a given shifted version of the N-bit mask used for a given other bit of the input value comprises the N-bit mask aligned with N bit positions of the output value such the corresponding location of the given other bit within the output value is identified by the one bit position in the given shifted version of the N-bit mask that has the mask bit value indicating the set state.

8. An apparatus as claimed in claim 5, wherein the input value comprises L bits, and L−1 shifted versions of the N-bit mask are formed, each shifted version being associated with one of the L−1 other bits of the input value.

9. An apparatus as claimed in claim 8, wherein the output value generation circuitry is arranged to generate L intermediate results, each intermediate result being generated by applying a version of the N-bit mask to its associated bit of the input value, and the output value generation circuitry comprises combining circuitry to logically combine the L intermediate results to generate the output value.

10. An apparatus as claimed in claim 9, wherein the output value has P bits, where P is greater than N, and each intermediate result includes P-N padding bit values provided in at least one of most significant bit positions and least significant bit positions of the intermediate result.

11. An apparatus as claimed in claim 10, wherein the given bit is the most significant bit of the input value, the intermediate result generated by applying the N-bit mask to the given bit has padding bits provided in the P-N least significant bit positions, and the intermediate result generated for each successive less significant bit of the input value has one more padding bit in the most significant bit positions than the intermediate result generated for an adjacent more significant bit of the input value.

12. An apparatus as claimed in claim 1, wherein the output value has more bits than the input value, the input value comprises L bits, and the output value generation circuitry is arranged to apply the N-bit mask so as to replicate the input value in a sequence of L bit positions within the output value.

13. An apparatus as claimed in claim 1, wherein the input value is a significand of a floating point value, and the shift indication amount is an indication of an exponent of the floating point value.

14. An apparatus as claimed in claim 13, wherein the output value is a fixed point value comprising more bits than are provided by the significand of the floating point value.

15. An apparatus as claimed in claim 1, wherein the output value has a same number of bits as the input value.

16. An apparatus as claimed in claim 15, wherein the shift implements a rotate such that the output value is a rotated version of the input value.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17 assembled on a further board with at least one other product component.

19. A computer-readable medium to store computer-readable code for fabrication of the apparatus of claim 1.

20. A method of performing a computation equivalent to applying a shift to an input value to generate an output value, comprising:
employing mask generation circuitry to generate an N-bit mask in dependence on a provided shift amount indication, where N is a number of possible bit positions that a given bit of the input value may be located within the output value after the shift is performed, the mask generation circuitry performing N independent logical operations on bits forming the shift amount indication, each logical operation producing a mask bit value for a corresponding bit position of the N-bit mask, and the N logical operations being arranged such that, for any given shift amount indication, only one bit position in the generated N-bit mask will have its mask bit value indicating a set state; and
applying the N-bit mask to the given bit of the input value in order to determine a corresponding location of the given bit within the output value, and determining a location within the output value of each other bit of the input value in dependence on the corresponding location of the given bit.
